(19) United States
(12) Patent Application Publication
(10) Pub. No.: US 2008/0224882 A1
(43) Pub. Date: Sep. 18, 2008

(54) Soldier bear

(76) Inventor: Nancy C. Hale, Oklahoma City, OK (US)

Correspondence Address: Nancy C. Hale, 10120 Southridge Terrace, Oklahoma City, OK, 73159, US

(21) Appl. No.: 11/716,748

(22) Filed: Mar. 12, 2007

(51) Int. Cl. H04R 9/06

(52) U.S. Cl. 340/692

(57) ABSTRACT

The technical disclosure of my invention is the pre-recorded sayings inside a sound module housed in a collectable plush bear, and also the fact that both pre-recorded and recordable sound modules will be used with specific wording that will be used in the pre-recorded left hand of the plush bear. The pre-recorded sayings are as follows:
We can do all things through Christ who strenghtens us.
America is free because of you.
You are my Hero.

### BACKGROUND OF THE INVENTION

The field of invention is the wordings in a sound module housed in a plush bear and the fact pre-recorded sayings are in the left hand of the bear and the right hand has a sound module that you can record a message to your loved ones or maybe record a dream or goal. The pre-recorded messages are as follows:
We can do all things through Christ who strengthens us.
America is free because of you.
You are my Hero.

### BRIEF SUMMARY OF THE INVENTION

The general idea is to patent the sayings in a sound module placed inside A keepsake collectable plush bear and to patent the fact both pre-recorded messages as well as a sound module that you can record a personal message are both housed in the same plush bear. The pre-recorded sayings are as follows:
We can do all things through Christ who strengthens us.
America is free because of you.
You are my Hero.

### DETAILED DESCRIPTION OF THE INVENTION

The details of my invention are as follows. A plush keepsake bear will be Manufactured for sale. The bears looks will be covered by a design patent, while the inter-workings of the bear are covered by the utility patent. The bear will have a special made sound module that will have pre-recorded sayings in the left hand of the bear while the right hand of the bear will have a button that you can record a special message to your loved one. The pre-recorded sayings are as follows:
We can do all things through Christ who strengthens us.
America is free because of you.
You are my Hero.

1. What I claim as my invention is the wording or sayings in a sound module housed in a plush bear, and also the fact the left hand has pre-recorded inspirational sayings in the sound module and the right hand has a button that you record your personal message to your loved ones, the sayings are as follows:
We can do all things through Christ who strenghtens us.
America is free because of you.
You are my Hero.
